(19) United States
(12) Patent Application Publication
(10) Pub. No.: US 2018/0349974 A1
(43) Pub. Date: Dec. 6, 2018

(54) SYSTEM AND METHOD FOR PRESENTING PRODUCT-SPECIFIC CONTENT ON A CLIENT DEVICE BASED ON A SCANNED BARCODE

(71) Applicant: Merck, Sharp & Dohme Corp., Rahway, NJ (US)

(72) Inventors: Debashis DUTTA, Rahway, NJ (US); Ifat SCHILLER, Salit (IL)

(73) Assignee: Merck Sharp & Dohme Corp., Rahway, NJ (US)

(21) Appl. No.: 15/778,903

(22) PCT Filed: Nov. 15, 2016
(86) PCT No.: PCT/US2016/062092

§ 371 Date: May 24, 2018

Related U.S. Application Data
(60) Provisional application No. 62/271,199, filed on Dec. 22, 2015.

(51) Int. Cl. G06Q 30/06; G06K 19/06; G06K 7/14; G06F 17/30

(52) U.S. Cl. CPC G06Q 30/0623; G06K 19/06037; G06K 2007/10504; G06F 17/30879; G06K 7/1417

(57) ABSTRACT

A system and method for presenting product-specific content on a client device, such as a smart cellphone, tablet, or laptop computer, based on a scanned DataMatrix barcode. A DataMatrix barcode is read by an optical scanner attached to the client device and an application recognizes and parses the data encoded in the DataMatrix barcode to obtain a unique alphanumeric identifier. The unique identifier is transmitted to a digital content server via a data communications network and used by the digital content server to retrieve product-specific content created and maintained on the digital content server by a content management system. The product-specific content, if found on the server, is transmitted to the client device and presented on an output device in accordance with a predefined presentation template.

### TECHNICAL FIELD

The present invention relates generally to content management and display systems for client systems and devices, such as cellphones and laptop computers, and relates more particularly to systems and methods for automatically locating, retrieving, organizing and presenting product-specific content on client devices based on product identifiers acquired by scanning 2D DataMatrix barcodes with a barcode scanner attached to the client device.

### BACKGROUND

Barcodes are one type of machine-readable data that can be applied to medical and pharmaceutical products. As such, they are widely used to encode information such as product numbers, serial numbers, expiration dates, and batch numbers, and they play a key role in supply chains, enabling parties like retailers, manufacturers, transport providers, and hospitals to automatically identify and track pharmaceutical products as they move through the supply chain. A DataMatrix barcode is a two-dimensional (2D) matrix barcode consisting of black and white “cells” or modules arranged in either a square or rectangular pattern. The information encoded in a DataMatrix barcode may comprise, for example, text or numeric data, and usually ranges in length from a few bytes up to 1556 bytes. Therefore, a single DataMatrix barcode can hold a significant amount of information. Consequently, DataMatrix barcodes are used in a wide range of industries, from manufacturing and warehousing, to logistics and healthcare.

The GS1 General Specifications Standard provides a common set of data and data carriers to be applied to medical and pharmaceutical products at every packaging level for a variety of different types of data carriers, including DataMatrix barcodes. The Automatic identification and Data Capture (AIDC) Standard for healthcare trade items has been incorporated into the GS1 General Specifications. One component of the AIDC Standard comprises the Global Trade Identification Number (GTIN), which provides a unique identification number for any healthcare item that is traded (i.e. priced, marketed, sold, ordered, invoiced, etc.).

In its current state, the GS1 General Specifications Standard requires embedding a uniform resource locator (URL) in a DataMatrix barcode in order to enable a client device, such as a smart cellphone equipped with a means of optically scanning barcodes, to present a specific web page on the Internet. However, embedding a URL in a DataMatrix barcode requires a DataMatrix barcode that is significantly larger than the DataMatrix barcode if the URL is omitted. Using larger DataMatrix barcodes on pharmaceutical product packaging increases the cost of manufacturing, marketing, and selling pharmaceutical products, and potentially creates a considerable amount of confusion, as some companies will inevitably choose to rely on older, cheaper mechanisms of providing URLs for web pages, such as by printing Quick Response (QR) codes on the packaging.

Accordingly, there is considerable need in the pharmaceutical products industry for a system and process for automatically identifying, retrieving, organizing and presenting product-specific content on a client device, such as a smart cellphone, based on scanning barcodes, such as a GS1 Standard 2D DataMatrix barcode, that does not include an embedded URL.

### SUMMARY OF EXEMPLARY EMBODIMENTS OF THE INVENTION

Embodiments of the present invention provide a system and computer-implemented method for presenting product-specific content on an output device (such as a display screen and/or speaker) connected to a client device, such as a smart cellphone. The product-specific content is transmitted to the client device from a digital content server based on a GTIN product-identifier that is input into the client device by scanning and decoding a standard DataMatrix barcode. Thus, embodiments of the present invention permit a user to scan a DataMatrix code printed on a pharmaceutical product package using his or her smartphone, and the smartphone responds by retrieving product-specific information from a remote digital content server and displaying that product-specific information on the smartphone's display screen. Notably, the standard DataMatrix code does not have a URL embedded within the barcode, which means the barcode can be a standard size and does not have to be enlarged in order to provide access to a rich collection of product-specific content associated with the product contained in the package containing the barcode.

In general, the system of the present invention includes a client device, an optical scanner connected to the client device, a client application running on the client device, and an output device, such as a display screen and/or a speaker. The system also includes a digital content server, a product information database containing the product-specific content for the product, and a server application running on the digital content server configured to search the product information database for the GTIN product identifier and to transmit to the client device any product-specific content found in the product information database that is associated with the GTIN product identifier. In some embodiments, the digital content server may further include an optional content management system (CMS) for creating, uploading and managing the product-specific content associated with the GTIN product identifiers stored in the product information database. The client device and the digital content server are suitably equipped with wired or wireless network interfaces configured to permit two-way data communication between the client device and the digital content server via a data communications network. The data communications network may comprise a wide area network (WAN), such as the Internet, a local area network (LAN), a private area network, an intranet, or any combination thereof.

Preferably, the client device is a mobile or handheld computer system, such as a smart cellphone or tablet computer, equipped with microprocessor, an image capturing device (such as a camera), an optical scanning program configured to cause the microprocessor and the image capturing device to operate together to detect, read and decode visible barcodes, such as DataMatrix barcodes affixed to the product or the packaging for the product. However, the client device may also comprise a variety of other types of devices, including without limitation, a laptop computer system, a desktop computer system, a computer workstation, or a wearable device, such as a smartwatch or set of smart eyeglasses. The client device is equipped with a microprocessor, a barcode scanning program and a peripheral barcode scanner, all configured for detecting, reading and decoding serialized 2D barcodes. The client device also includes an output device, such as a display screen and/or speaker, for presenting the product-specific content to the user.

It will be understood by those skilled in the art that, in addition to creating and presenting product-specific content for pharmaceutical products and medical devices, embodiments of the present invention may also be configured to provide and present product-specific content for many other types of traded products, such as, for example, food, electronics, and other consumer goods and articles of manufacture. The product-specific content stored in the product information database and presented on the output device of the client device may include, for example, brand and marketing information, operating instructions, user guides, emergency contact numbers, authenticity data, storage and recycle instructions, and the like. The format of the records in the product information database may include, without limitation, text, images, pictures, video clips, audio clips, web pages, links (e.g., URL addresses) for web pages, music, or any combination thereof.

In some embodiments, the client device further includes a presentation template, which defines a specific layout (e.g., size, location, orientation, color scheme, font scheme, language, etc.) for one or more elements of the product-specific content when the content is presented on the display screen of the client device and/or played on a sound output device. In these embodiments, the client application on the client device may further include programming instructions that, when executed by the microprocessor on the client device, cause the microprocessor to arrange, display and/or play the elements of the product-specific content in accordance with the layout defined by the presentation template.

If the output device is a smart cellphone or tablet computer, for example, the presentation template may define graphical control elements that provide functionality for a graphical user interface displayed on the output device. In addition to presenting detailed product-specific information in an easily comprehensible format, the graphical user interface, operating in conjunction with the client application, permits the user to navigate and utilize content presented in a wide range of formats, including, but not limited to, text, images, shared documents, audio and video files. The client application may also contain features that permit the user to store, retrieve, and manage personal data that relates to the product-specific information displayed by the system. The graphical user interface enables the client device to function in an interactive manner, and not simply as a passive display device. For example, as applied to the pharmaceutical industry, patient information, such as a medication regime schedule and reminders can be created and modified on the client device by the end user (or patient), which provides an added level of control for the end user. As a result, patient treatment outcomes can be improved through the use of the system of the present invention.

The present invention may be implemented using software, hardware or any combination thereof, as would be apparent to those of skill in the art, and the figures and examples below are not meant to limit the scope of the present invention or its embodiments or equivalents.

### BRIEF DESCRIPTIONS OF THE DRAWINGS

The various benefits and advantages of certain the embodiments of the present invention will become apparent to one skilled in the art by reading the following specification and appended claims, and by referencing the following figures, in which:

FIG. 1 shows a high-level block diagram of a computer network configured to operate according to one embodiment of the present invention;

FIG. 2 shows a high-level flow diagram illustrating by way of example the steps that may be performed by one or more application programs running on the client device to scan, decode and parse a 2D DataMatrix barcode, and to send a unique GTIN embedded in the scanned barcode to a digital content server in accordance with one embodiment of the present invention.

FIG. 3 depicts a high-level flow diagram illustrating by way of example the steps that may be performed by one or more server programs running on the digital content server to locate product-specific content in a product information database based on a unique GTIN and transmit that product-specific content to a client device in accordance with one embodiment of the present invention.

FIG. 4 shows a high-level flow diagram illustrating by way of example the steps that may be performed by one or more programs running on the client device to receive the product-specific content from the digital content server and to present the product-specific content on the output device of the client device according to one embodiment of the present invention.

FIG. 5 is a flow diagram illustrating by way of example the steps that may be performed by a content management system (CMS) to create and/or upload product-specific content for the product information database according to an embodiment of the present invention.

FIG. 6 shows an example of a layout for a display screen as defined by a presentation template according to an embodiment of the present application.

FIGS. 7A-7D show examples of display screens in a graphical user interface for a client application running on the client device, providing user authentication and navigation functionality, according to an embodiment of the present invention.

FIGS. 8A-8C show examples of display screens in a graphical user interface of a client application running on the client device, providing user access to medication guidelines and support information, according to an embodiment of the present invention.

FIGS. 9A-9C show exemplary display screens of a graphical user interface of a client application running on the client device, the display screens providing user access to multimedia content, according to an embodiment of the present invention.

FIGS. 10A-10C show exemplary display screens of a graphical user interface of a client application running on the client device, the display screens providing user access to safety and patient information, according to an embodiment of the present invention.

FIGS. 11A-11C show exemplary display screens of a graphical user interface of a client application running on the client device, the display screens providing user access to prescription regimen schedule reminders, according to an embodiment of the present invention.

FIGS. 12A-12D show exemplary display screens of a graphical user interface of a client application running on the client device, the display screens providing user access to reminder schedule frequency and time, as well a display options, according to an embodiment of the present invention.

FIGS. 13A-13D show examples of display screens that may be displayed on the client device during a scanning operation, according to an exemplary embodiment of the present invention.

FIG. 14 shows an example of a display screen for a graphical user interface, the display screen configured to facilitate user access to the content data of a content management system according to an embodiment of the present invention.

FIG. 15 shows an example of a display screen for a graphical user interface, the display screen providing access to the product data of a content management system according to an embodiment of the present invention.

FIG. 16 shows an example of a display screen for the graphical user interface configured to operate according to an embodiment of the present invention, the display screen configured to support the entry and editing of GTIN information in a content management system.

FIG. 17 shows an example of a graphical user interface supporting data entry and editing of user profiles for authorized users of a content management system according to an embodiment of the present invention.

FIGS. 18-24 show exemplary display screens for a graphical user interface operating on the client device according to an embodiment of the present invention, the exemplary display screens configured to help a product or marketing manager edit and modify the product-specific content associated with various products.

FIG. 25 is a diagram of a database table utilized by one exemplary embodiment of the present invention.

### DETAILED DESCRIPTION OF EXEMPLARY EMBODIMENTS

Non-limiting examples of devices and methods arranged and performed according to certain embodiments of the present invention will now be described in some detail by reference to the accompanying figures.

In a typical use scenario, a digital content server is connected to a wide area network (WAN), such as the Internet, so that multiple client devices may send requests to the digital content server to locate, retrieve and transmit product-specific content associated with a particular GTIN in a product information database on the digital content server. A content management system (CMS) running on the digital content server is used by a product manager or marketing manager to enter a product identifier (such as a GTIN) for a traded product, along with product-specific content for the traded product. Preferably, the CMS has a web-based user interface to facilitate data entry and/or data uploads. The CMS is communicatively coupled to a product information database, which stores the GTIN along with the product-specific content. The GTIN typically serves as a key field for searching the records contained in the product information database. The records in the product information database may contain text, audio and video (or pointers to text, audio and video), as well as other materials associated with the products. Some materials in the product information database may serve as triggers for the client device to perform a specific action, such as to download and play a video file. As such, the CMS may be configured to permit the product manager or marketing manager for the product to upload actionable materials into the product information database. For example, if the triggered action is to drive marketing related activities, then the relevant materials may comprise brand images, “how to” videos, patient medication guides, etc.

When a visible barcode, such as a DataMatrix barcode, is optically scanned by the optical scanner attached to the client device, the embedded dataset carried by the barcode is read, interpreted and parsed to isolate the dataset in the barcode. An optical scanning application or program running on the client device is configured to control the operation of the optical scanner. The application program on the client device may also be configured to run a preliminary check on the validity of the dataset embedded in the barcode. The Barcode Scanner SDK, available from Manatee Works (www.manateeworks.com), is one example of a barcode scanning program that may be adapted and used in one embodiment of the client device of the present invention. The client device may be configured to parse the dataset carried by the barcode in accordance with a set of barcode parsing rules stored on the client device. The set of barcode parsing rules may be provided, for example, by installing and configuring the GS1Lib Demo Webservice, which is made available to the public by the GS1 Standards organization. A microprocessor on the client device, operating under the control of the client application program, isolates the components of the barcode data, identifies the GTIN portion of the barcode data, and transmits the identified GTIN to the digital content server via a network interface to a data communications network, such as the Internet or another wide area network (WAN).

Upon receiving the GTIN from the client application program, a microprocessor on the server, operating under the control of a server application, searches the product information database for a match for the GTIN. If a match for the GTIN is not found in the product information database, then an error message is sent back to the client device indicating that the product cannot be found. On the other hand, if a match for the GTIN is found in the product information database (i.e., there is a match between the GTIN scanned by the client device and a GTIN in the product information database on the server), then the server application on the digital content server causes the microprocessor to retrieve from the product information database some or all of the product-specific content associated with that particular GTIN and transmit that content back to the client device via the data communications network. When the client device receives the client-specific content from the digital content server, the content is displayed or presented on the output device (e.g., a display monitor, speakers, or both) associated with the client device. The format, arrangement, appearance and sound of the elements of the product-specific content may be predetermined in accordance with one or more presentation templates stored on the client device. In embodiments of the present invention, the client device may comprise a smart phone, digital tablet, wearable digital computing device, or personal digital computer configured to access, process, and present information associated with a particular product to an end user.

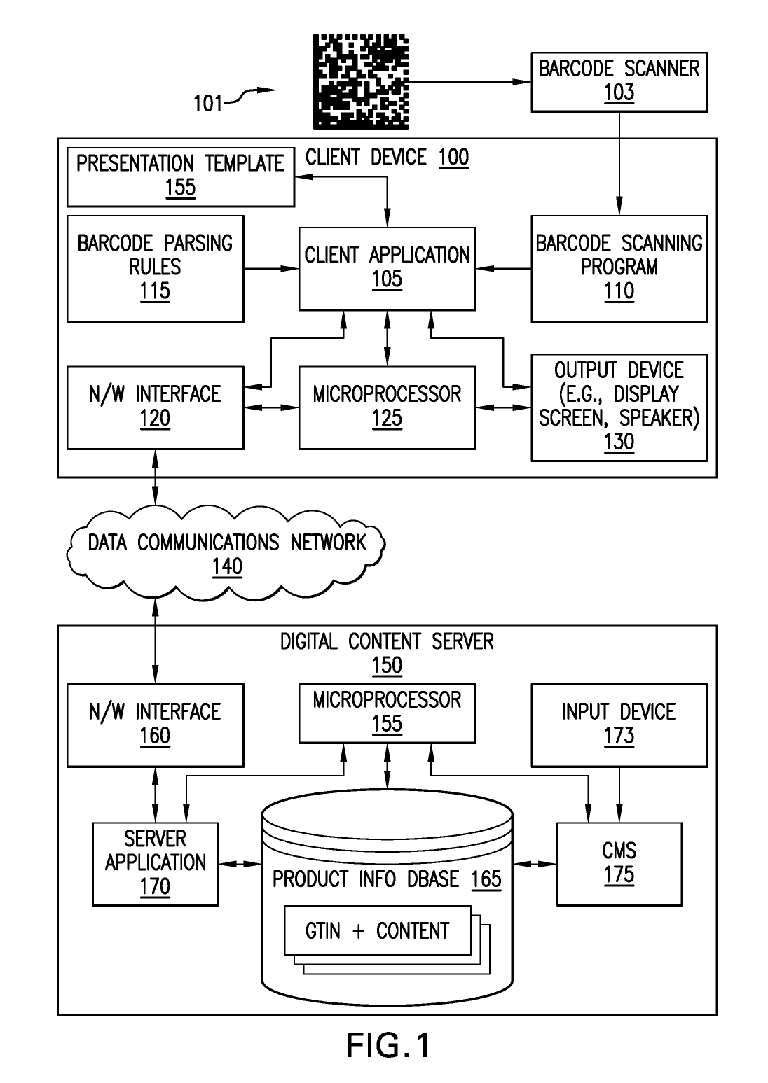

FIG. 1 shows a high-level block diagram illustrating an exemplary computer network 100 configured to operate according to one exemplary embodiment of the present invention. As shown in FIG. 1, the exemplary computer network 100 comprises a client device 102, which is connected to a digital content server 150 via a data communications network 140. Client device 102 acquires data encoded within a 2D DataMatrix barcode 101 using an optical barcode scanner 103. The barcode scanner 103 may be built into the client device 102, as in the case of a camera built into a smart cellphone, or it could be an independent scanner device electronically connected to the client device 102.

As shown in FIG. 1, the client device 102 includes a client application 105, which comprises program instructions that cause a microprocessor 125 to execute a series of operations, which will be discussed in further detail below. The client application 105 receives data from the optical barcode scanner 103 by the operation of barcode scanning program 110 configured to drive the operation of the barcode scanner 103. The client application 105 is able to interpret the scanned data using a set of barcode data parsing rules 115. The barcode data parsing rules 115 may (or may not) be derived from an industry standard. The client application 105 also transmits and receives digital information via a network interface 120, which is connected to a data communications network 140, and presents information to the end user on an output device 130. In one embodiment, a presentation template 155 defines the specific layout (e.g., size, location, orientation, color scheme, font scheme, language, etc.). In other embodiments of the present invention, the client application 105 itself may include program instructions that control the specific layout of the information presented to the user. It is understood by those skilled in the art that multiple presentation templates 155 defining layout designs may be stored on the client device 102.

Also shown in FIG. 1 is a digital content server 150, which has at its core a microprocessor 168 and a server application 165, which contains program instructions that cause the microprocessor 168 to execute a series of operations that enable the entry, editing, access, retrieval, and communication of a structured set of records stored in a product information database 170. Specific records can be selected and retrieved from the product information database 170 and communicated over the data communications network 140 by means of network interface 160. The records in the product information database 170 are created and managed by a content management system 175, which is accessed and operated by a back end user, such as a product manager or marketing manager, through an input device 180, which may be connected directly to the digital content server 150, or otherwise connected to the digital content server 150 via a local access network (not shown in FIG. 1).

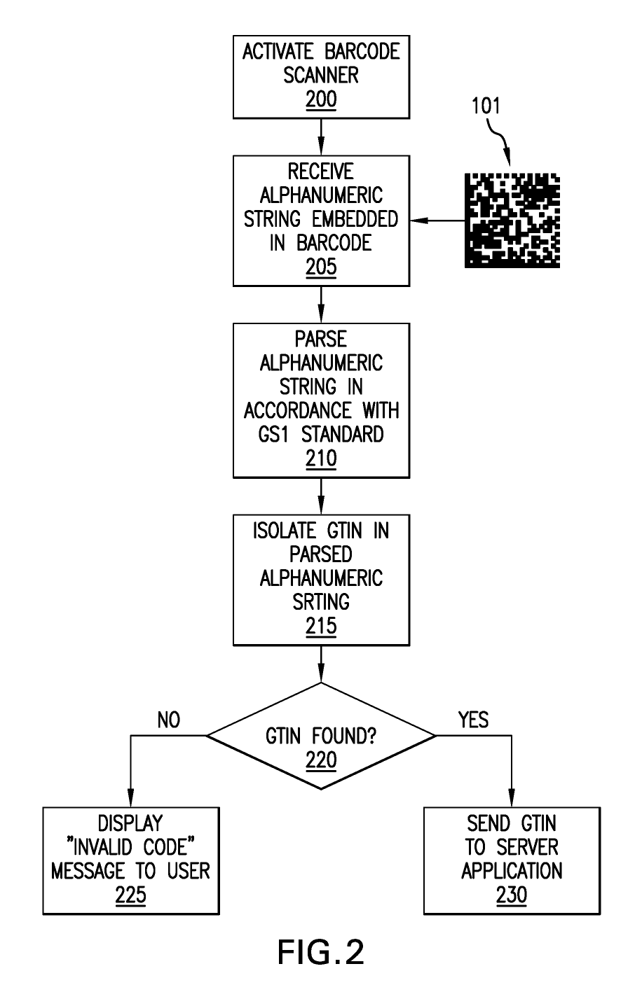

FIG. 2 shows a high-level flow diagram illustrating by way of example the steps that may be performed by the client application 105 running on the client device 102 to scan, decode and parse a 2D DataMatrix barcode, and to send a unique GTIN embedded in the scanned barcode to the digital content server 150 in accordance with one embodiment of the present invention. As illustrated by the exemplary flow diagram of FIG. 2, certain embodiments of the present invention derive a specific alphanumeric identifier embedded within a 2D DataMatrix barcode by means of an algorithm supported by one or more applications running on client device 102 described above. At the start of the algorithm, at step 200, activation instructions cause an optical scanner to be placed in a state of readiness to identify and read a visible 2D DataMatrix barcode 201. At step 205, an alphanumeric string embedded in the 2D DataMatrix barcode 201 is received by the optical scanner, which is then parsed at step 210 in accordance with an accepted industry standard. Next, at step 215, a unique identifier is isolated from within the alphanumeric string. In some embodiments of the present invention, the unique identifier is a Global Trade Identification on Number (GTIN) described above. But it will be understood by those skilled in the art that parsing rules can be developed to parse and isolate a wide range of product identifiers besides GTINs.

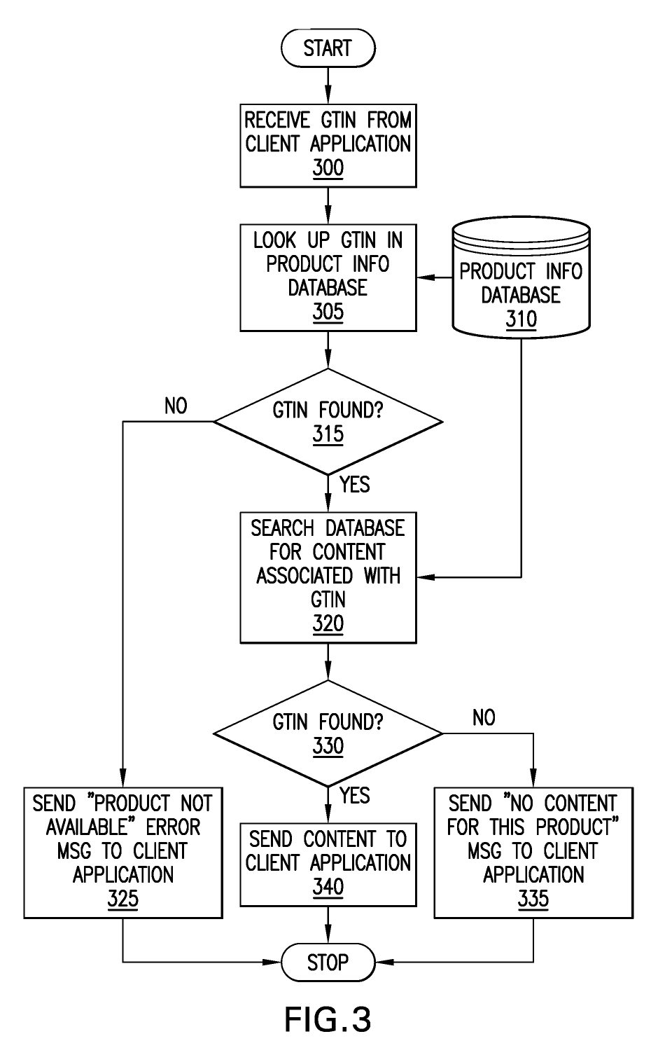

In some embodiments, the client device 102 includes a local database (not shown in FIG. 1), which stores a list of valid unique product identifiers for the system. At step 220 of FIG. 2, the client device 102 checks the local database to determine whether the unique identifier derived from the scanned data is valid. If the unique identifier is not found in the local database, and error message is displayed (at step 225) to the end user, and the process halts. However, if the unique identifier is found in the local database, then the unique identifier is sent, at step 230, to the digital content server 150 via the network interface 120 for further processing in accordance with the algorithm shown in FIG. 3 and discussed below.

The GTIN provided by the client device 102 may be processed on the digital content server 150 in accordance with the algorithm illustrated in FIG. 3. As the process starts, a unique identifier is received at step 300, which is then compared at step 305 to an existing set of records associated with a given range of unique identifiers stored in the product information database 310. At step 315 the digital content server 150 determines whether the GTIN received at step 300 matches any GTIN already present in the product information database 310. Each of the identifiers (e.g. GTINSs) stored in the product information database 310 is associated with a specific product record containing distributable content. If it is determined at step 315 that no matching GTIN is currently present within the product information database 310, then at step 325 an error message is relayed via the data communications network 140 to the client device 102 as discussed above and shown in FIG. 1, and the process halts.

On the other hand, if a match for the unique identifier provided to the digital content server 150 by the client device 102 is found in the product information database 310, then, at step 320, the product information database 310 is searched for distributable product-specific content associated with that GTIN. If it is determined at step 330 that no distributable content for the GTIN is currently stored in the product information database 310, then at step 335 an error message is relayed via the data communications network 140 to the client device 102, and the process halts. If it is determined at step 330 that the product information database does contain distributable content associated with the specific GTIN, then this content is transmitted via the data communications network 140 to the client device 102 at step 340, and the process halts.

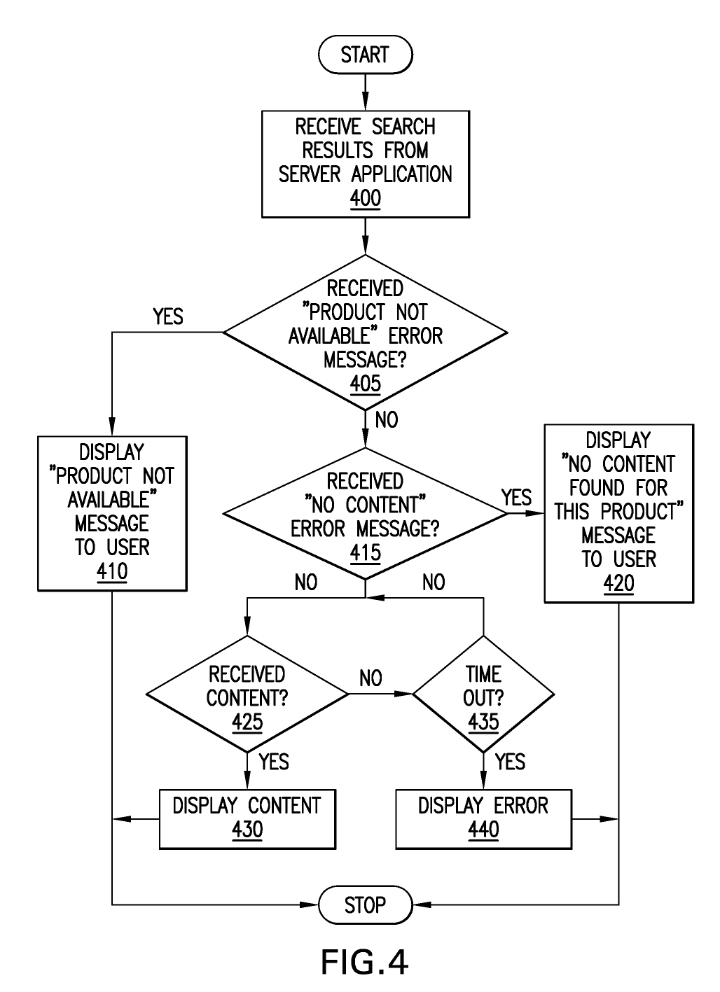

FIG. 4 shows a high-level flow diagram illustrating by way of example the steps that may be performed by one or more programs running on the client device to receive the product-specific content from the digital content server and to present the product-specific content on the output device of the client device according to one embodiment of the present invention. As shown in FIG. 4, the client device 102 receives the search results at step 400. What follows is a series of conditional steps that result in the appropriate information being transmitted to and/or played on the output device 130 of client device 102. At steps 405 and 415, the client device 102 does a check to determine whether a “product not available” error message or a “no content” error message was received from the digital content server 150. If this is the case, an appropriate error message is displayed to the end user in steps 410 or 420, and then the program stops.

If this is not the case, the system determines at step 425 whether all of the data for the requested content has been received, and if this is the case, the content is displayed at step 430 on the output device 130 of client device 102, and the process halts. If this is not the case, the system determines at step 435 whether the data reception cycle has timed out. If the reception cycle has not timed out, the system will continue waiting to receive all of the data packets of the requested content (the waiting is reflected in the loop defined by steps 425 and 435). However, if the data reception cycle does reach its maximum time out threshold, then a suitable error message is displayed at step 440 on the output device 130 and the process halts.

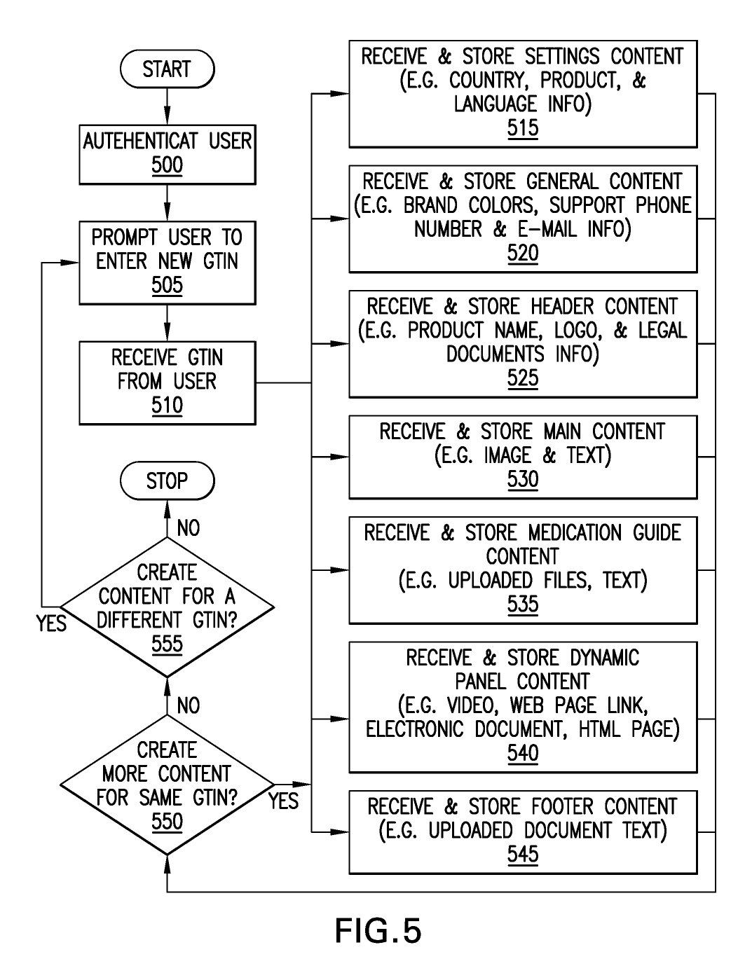

Digital content can be created and edited by back end users, such as product managers or marketing managers, to make new content available or to update existing content stored in the product information database 170, as discussed previously in relation to FIG. 1, by the operation of a content management system 175 running on the digital content server 150. FIG. 5 shows the steps of an exemplary algorithm that may be executed by the content management system in one embodiment of the present invention. At the start of the procedure, when the back end product or marketing manager logs into the system, the back end user's logon identity is authenticated at step 500. Next, the back end user is prompted to enter a unique identifier at step 505. In one exemplary embodiment of the invention, the unique identifier is a GTIN, and this will be associated with a particular pharmaceutical product. It will be understood by those skilled in the art that this approach can also be applied to a wide variety of different types of products in a wide variety of industries besides pharmaceuticals. Once the content management system 175 receives the GTIN at step 510, the back end user now has the option of proceeding to any one of a set of distinct digital data entry and editing forms, each of which correspond to a specific segment of the presentation template 155, the details of which will be described in further detail below.

At step 515, the back end user can enter or edit information relating to country and language-specific settings. At step 520, the back end user can enter or edit details relating to general content, such as brand color and pharmaceutical product support information. At step 525, the back end user can enter or edit pharmaceutical product information that would be displayed in the header of the output device 130 of client device 102. At step 530, the back end user can enter or edit content that will be displayed in the main area of the output device 130, such as an image of the pharmaceutical product and the appropriate text. At step 535, the back end user can enter or edit a medication guide, in the case of a pharmaceutical product, and this may take the form of text or stored files. At step 540, the back end user can enter or edit content that would be displayed dynamically, such as video or audio files, or active links to pages viewable on the World Wide Web. At step 545, the back end user can enter or edit information that would be displayed in the footer of the output device 130.

At each of the steps 515-545, the back end user has the option of creating or editing additional content associated with the same GTIN originally entered at step 505, illustrated by the conditional step 550, or creating or editing content for another GTIN, illustrated by the conditional step 555. If the back end user chooses to create or edit content for another GTIN, processing returns to step 505 wherein the user is prompted to enter a new GTIN. If not, the process halts.

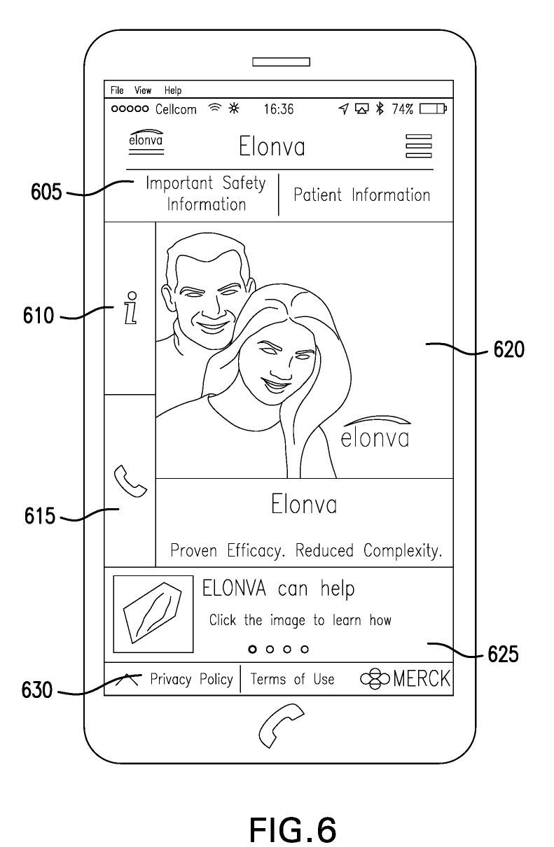

FIG. 6 shows an example of a display screen and graphical user interface for the client application 105 running on a client device 102, such as a smart phone, organized in accordance with the presentation template 155 of one embodiment of the present invention. Content associated with the header 605 is accessible at the top of the smart phone screen. To the left of the screen are active tiles providing a means for an end user to access pharmaceutical product information 610 and support information 615 by means of tapping or swiping the touch-sensitive screen. In this example, the center of the screen 620 is used to display the name and brand photo for a marketed product (“Elonva”). Below this is the dynamic panel 625, by which additional content, such as video, audio, document files, or external web pages, which have all been associated with a specific product, can be displayed and accessed by the end user. The footer 630 at the bottom of the display screen provides user access to privacy policy and terms of use information.

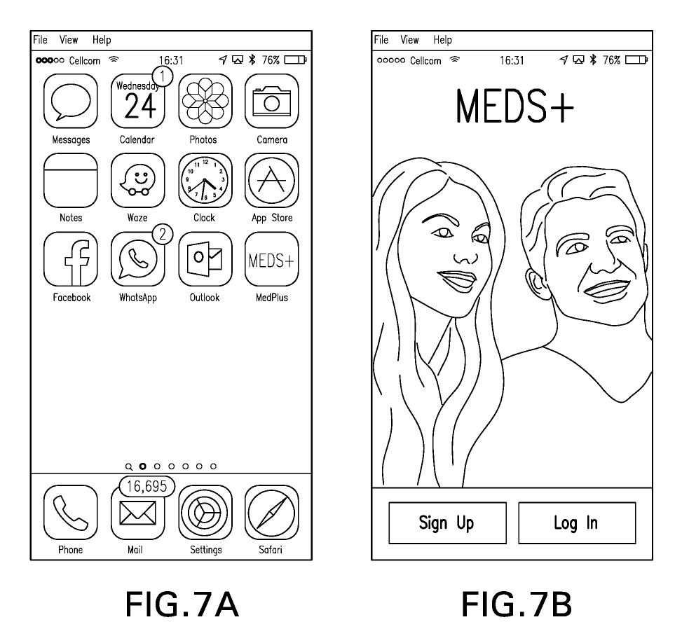

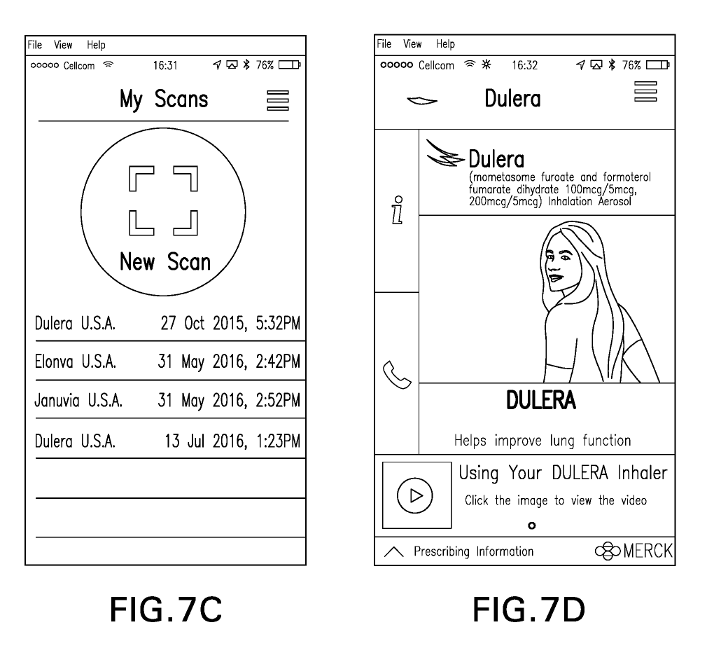

FIGS. 7A, 7B, 7C and 7D depict exemplary display screens for a graphical user interface configured to operate in accordance with one exemplary embodiment of the present invention. In this instance, the client device is a camera-equipped smart phone with a touch screen display. FIG. 7A shows the tile or icon that launches the application from the main screen of the smart phone operating system, the tile identified here as “MEDS+.” FIG. 7B shows the initial logon screen of the MEDS+application, which gives the end user the option to login in or create a new user identification. FIG. 7C shows the main screen of the application following a successful logon. Here, the end user has the option of selecting the action to scan a new barcode, or select from a list of previously scanned items in order to view its contents. FIG. 7D shows an example of the product contents available for one of the previously scanned items, presented in a layout as defined by the presentation template 155 employed by client application 105 shown in FIG. 1.

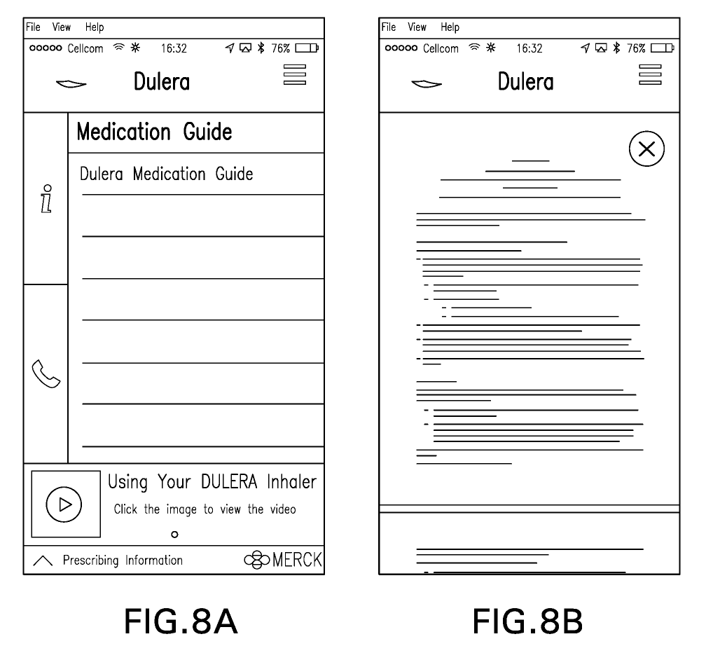

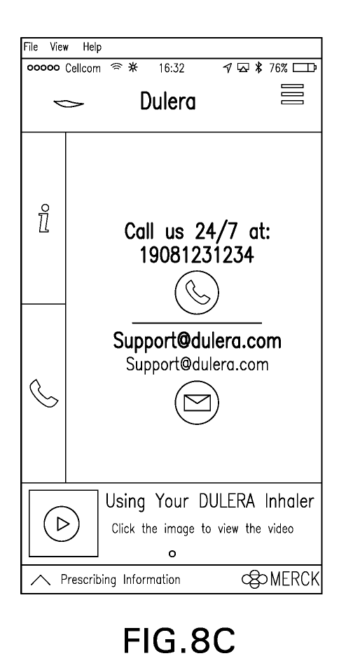

FIGS. 8A, 8B and 8C depict graphic user interfaces for an exemplary embodiment of the present invention running on a smart phone. FIG. 8A shows a listing of available information, accessed by tapping the “i” tile or icon on the left side of the display template 155. In this instance, the available information shown is a medication guide. FIG. 8B shows the smart phone screen displaying a digital document file, which is the medication guide content as provided by the digital content server 150, viewable by selecting the medication guide item from the list shown in FIG. 8A. FIG. 8C depicts the product support content, accessed by tapping the “telephone” tile or icon on the left side of presentation template 155.

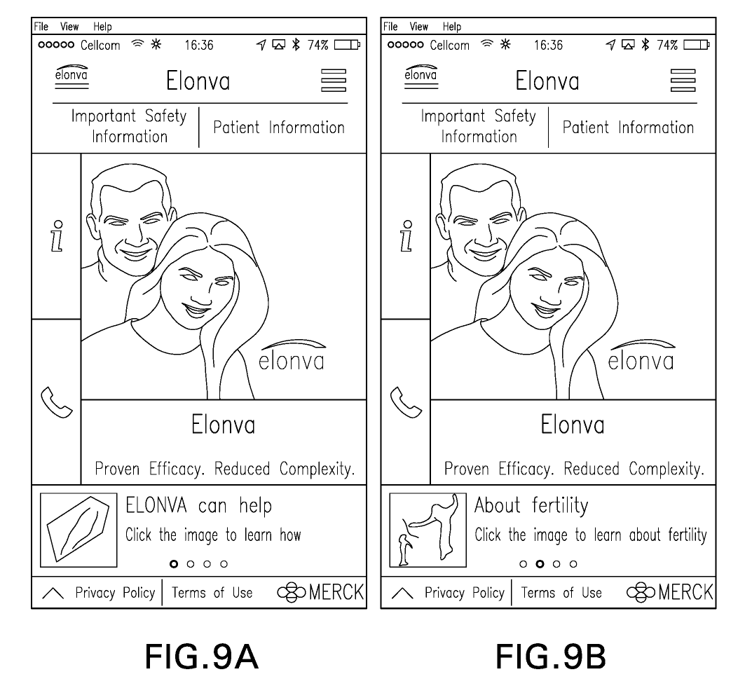

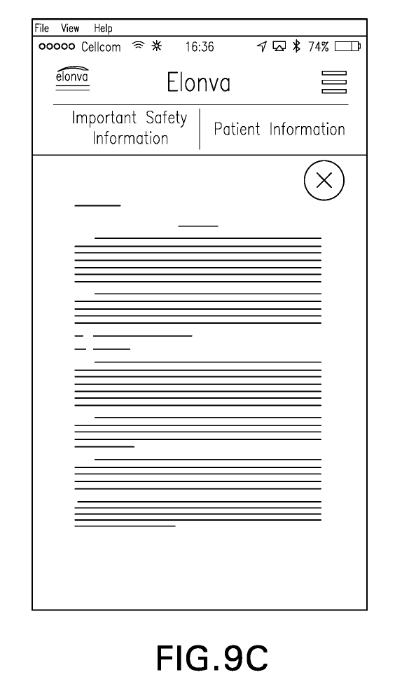

FIGS. 9A, 9B and 9C depict the fully-rendered available content as an end user would be able to view on a smart phone in accordance with an exemplary embodiment of the present invention. FIG. 9A shows a dynamic window feature below the main image and text associated with a particular pharmaceutical product. FIG. 9B shows a second option presented in the dynamic window feature, and FIG. 9C shows the smart phone screen displaying a digital document file, which in this instance is information relating to a medical condition.

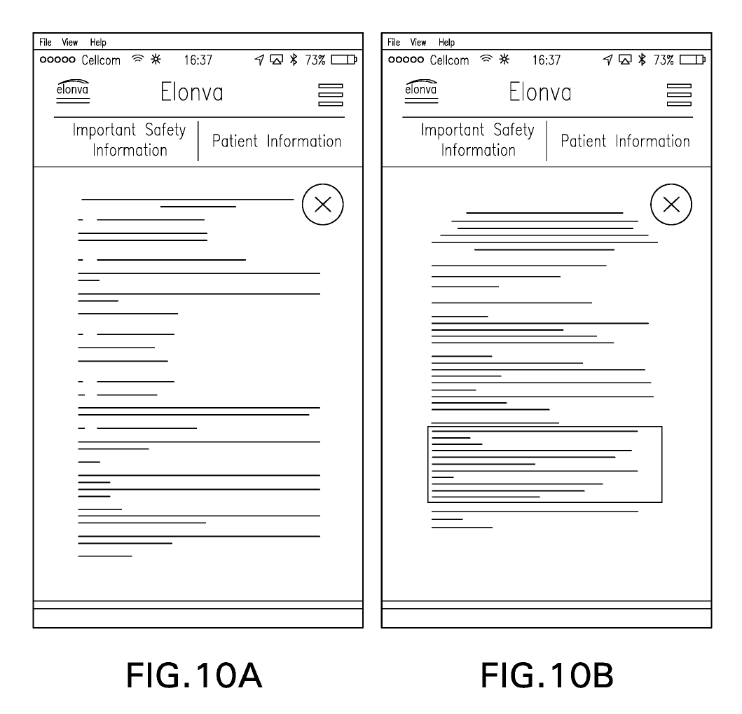

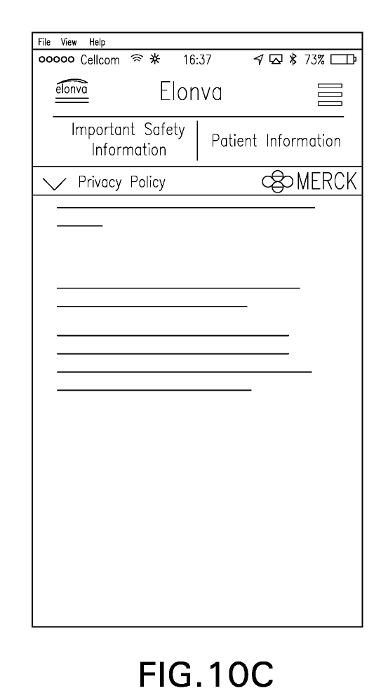

FIGS. 10A, 10B and 10C depict another instance of the fully-rendered available content as an end user customer would be able to view it on a smart phone in accordance with an exemplary embodiment of the present invention. FIG. 10A shows the important safety information in the form of a digital document file viewable within the display screen of the client device in accordance with an embodiment of the present invention. FIG. 10B shows the relevant patient information in the form of a digital document file. FIG. 10C shows the text associated with the privacy policy, accessed by selecting the privacy policy option available in the footer.

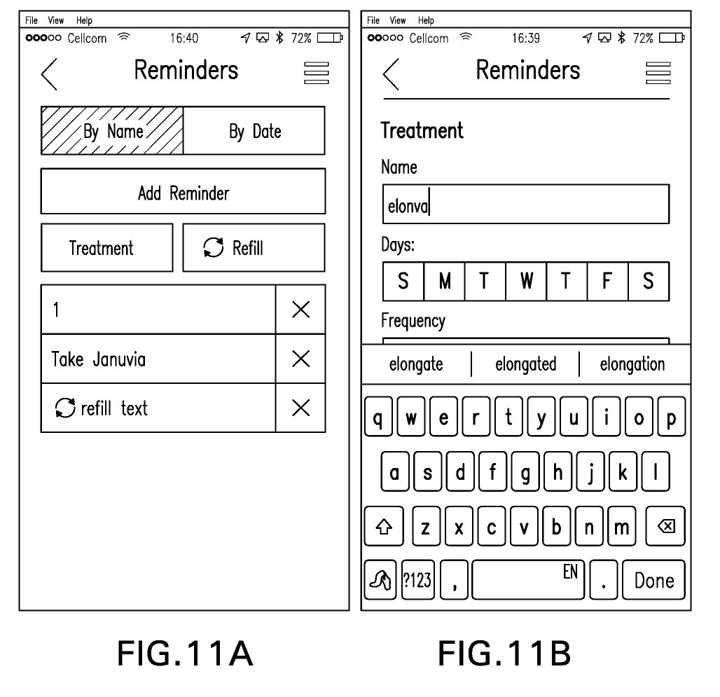

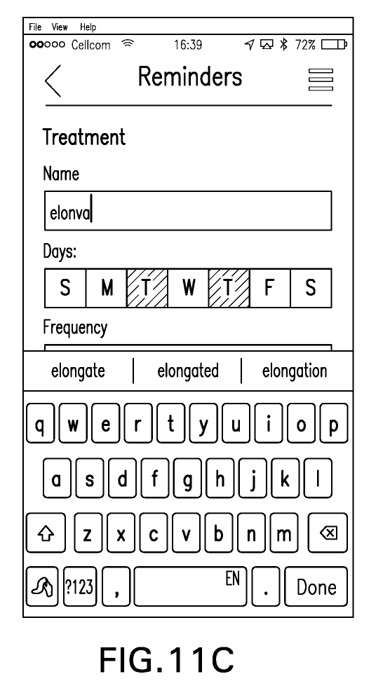

FIGS. 11A, 11B and 11C depict a graphical user interface of one exemplary embodiment of the present invention, with which an end user customer can set and edit reminders as they related to pharmaceutical products. FIG. 11A shows a list of reminders already created and organized by name. FIG. 11B shows the graphical user interface for entering or editing a reminder name, and FIG. 11C shows the graphical user interface for selecting specific days of the week on which to receive reminders. All reminders in this embodiment of the present invention are entered by the end user customer by means of tapping specific graphic tiles or icons on the touch sensitive screen of a smart phone.

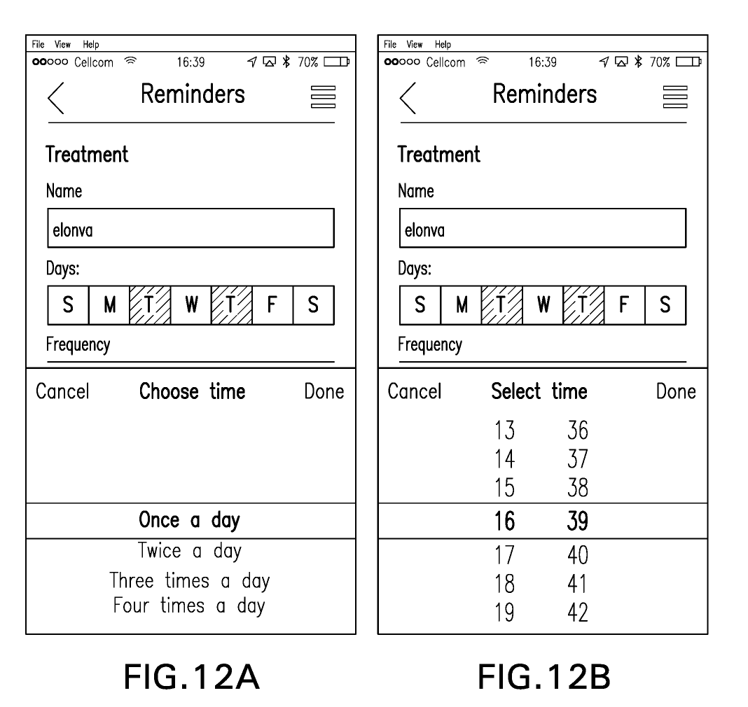

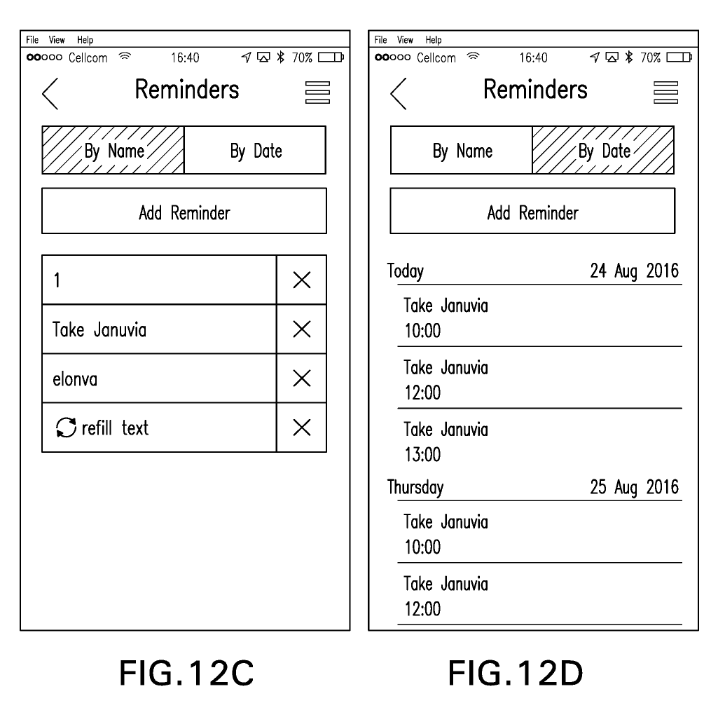

FIGS. 12A, 12B, 12C and 12D depict a graphical user interface of one exemplary embodiment of the present invention, with which an end user customer can further set and edit reminders as they relate to pharmaceutical products. FIG. 12A shows the available reminder frequency options. FIG. 12B shows the available reminder time options. FIG. 12C shows an updated reminder list with a new reminder added, and FIG. 12D shows a list of reminders with the option to display each one by the reminder date.

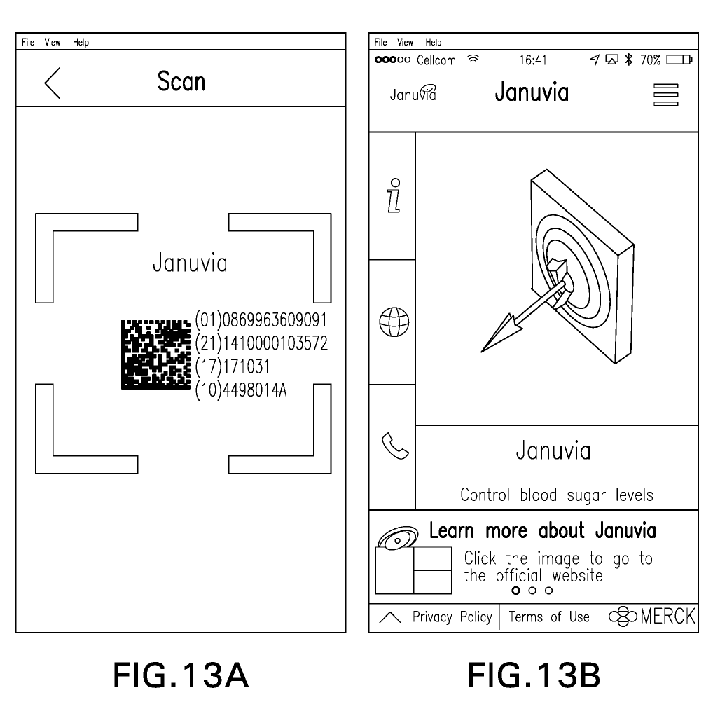

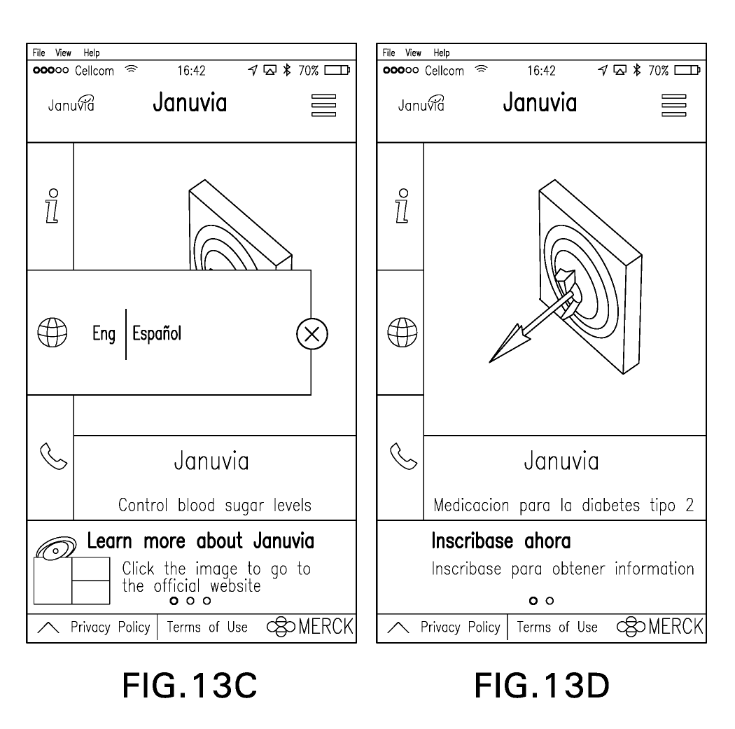

FIGS. 13A, 13B, 13C and 13D depict the user interface of one exemplary embodiment of the present invention, detailing the scanning feature that an end user can use in order to scan a DataMatrix barcode with smart cellphone's built-in camera. FIG. 13A shows the barcode targeting screen for aligning the lens with a 2D DataMatrix barcode. FIG. 13B shows the product-specific content obtained following the scan of said barcode, fully rendered and available for consumption via the display screen. FIG. 13C shows available language content and options, and FIG. 13D shows the same content, now readable in a language other than English. As previously stated, the layout of the display screen in FIGS. 13B-13D may be defined in a presentation template 155 stored on the client device 102.

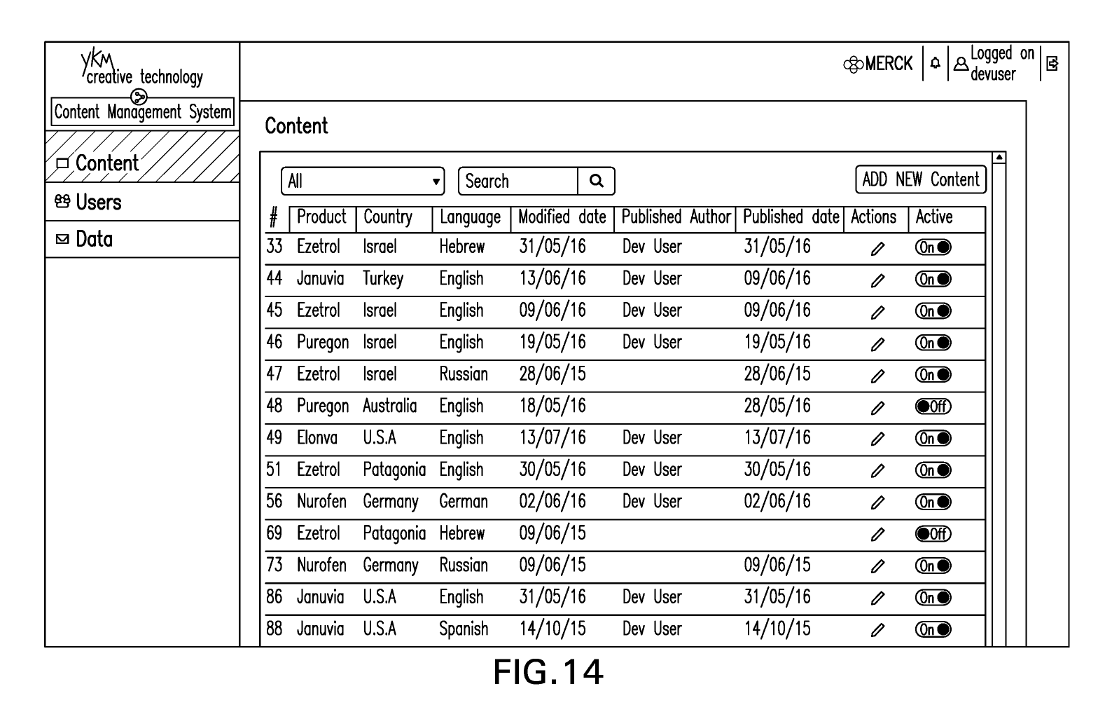

FIG. 14 shows an example of a display screen in a graphical user interface for a data entry and editing session in a content management system 175 configured to operate in accordance with one exemplary embodiment of the present invention. In this instance, the product manager or marketing manager is using the content management system 175 to create or modify the records of the product information database 165. Each record is associated with a unique GTIN.

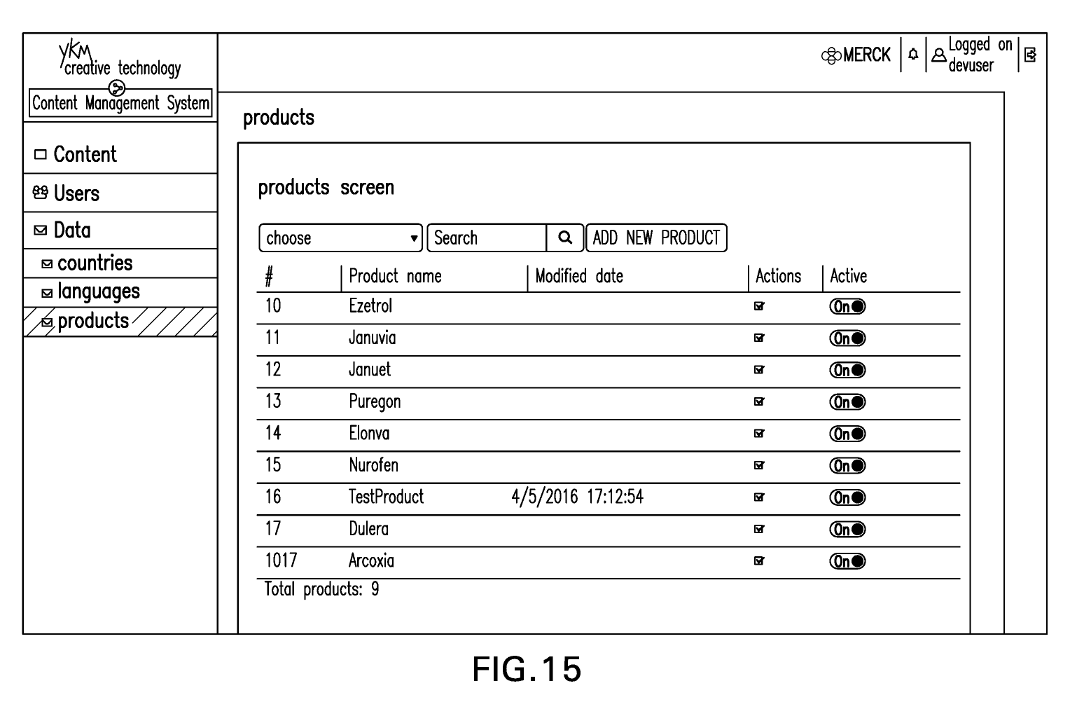

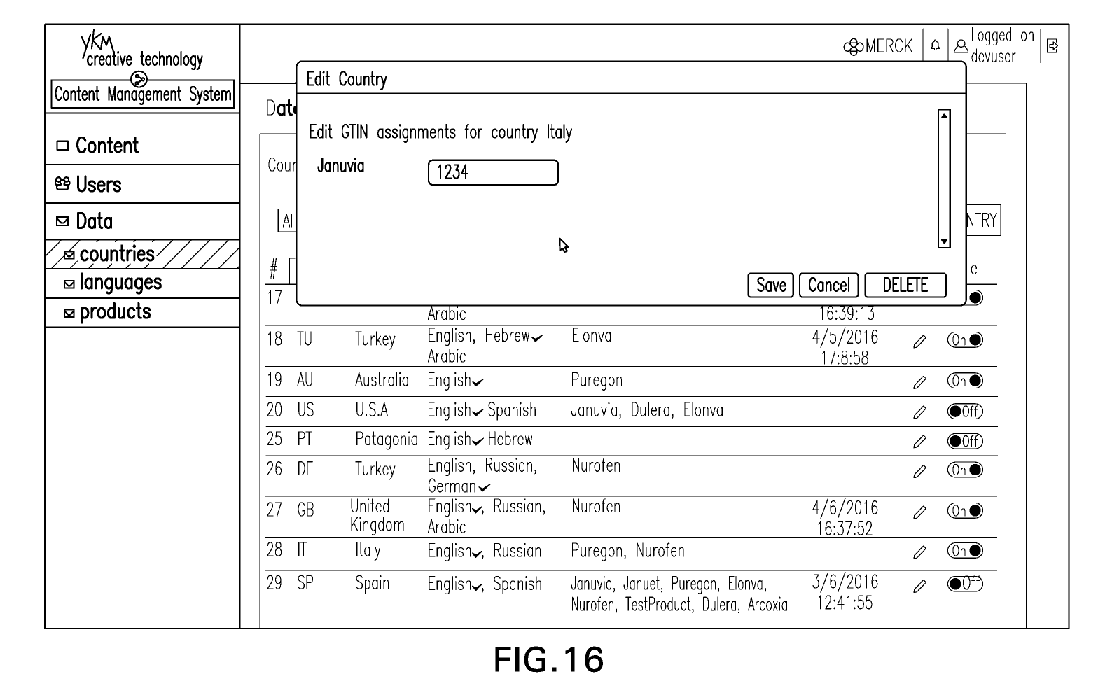

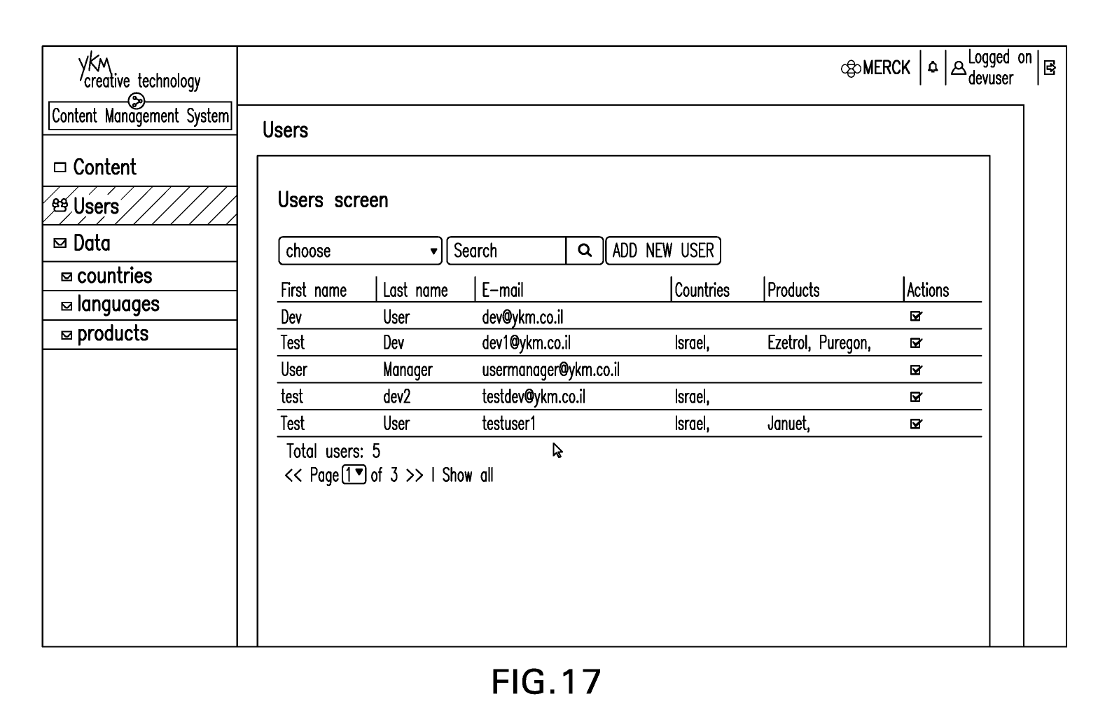

FIG. 15 depicts a graphical user interface of a data entry and editing system running on a web browser showing product names, and a general depiction of the schema used to organize this table within the product information database 165. FIG. 16 shows the interface for assigning specific GTINs to any particular country as a means of creating specific associations for content that will be available in said country. FIG. 17 shows the user profile table, and a general depiction of its schema, which gives the administrator of the content management system 175 the ability to add, delete, and modify authorized users, who will enter and modify product information records and the files that will become distributable content in accordance with one exemplary embodiment of the present invention.

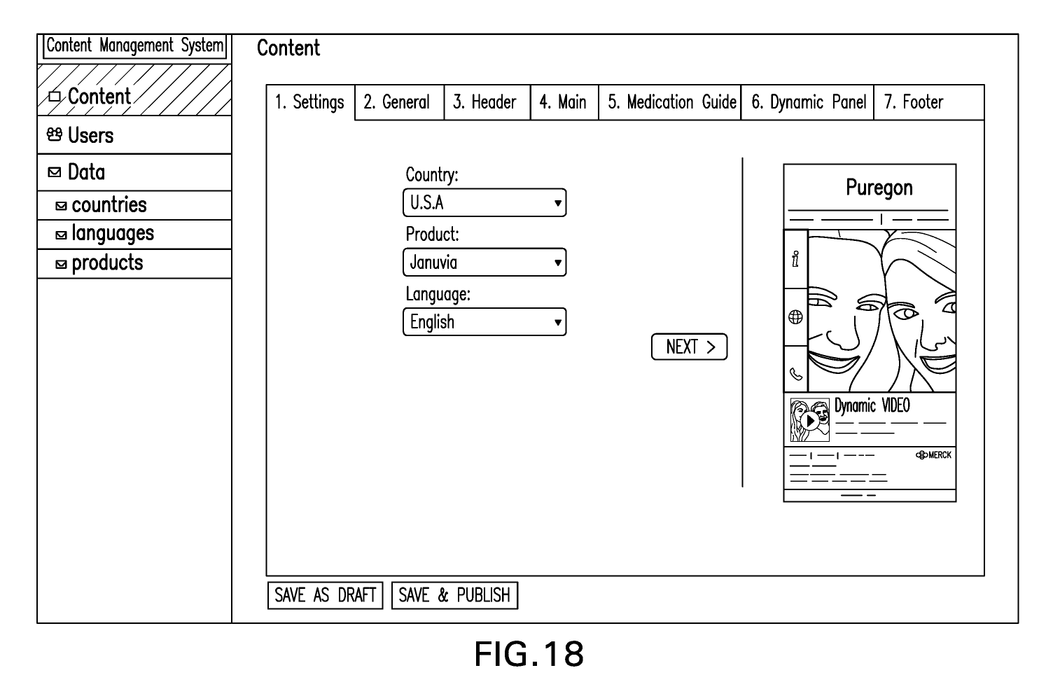

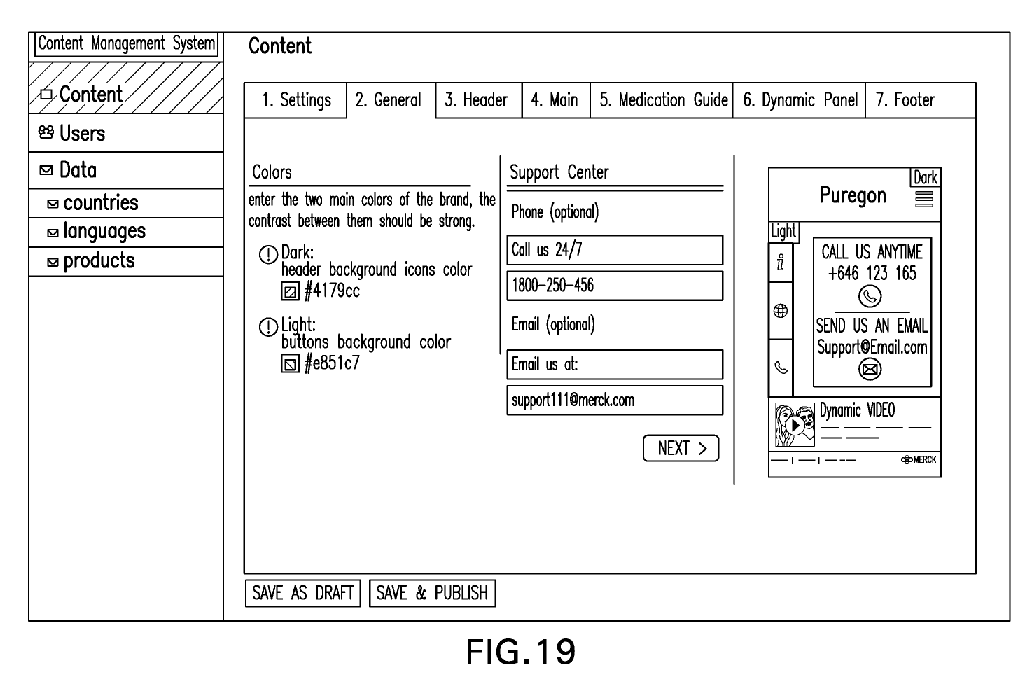

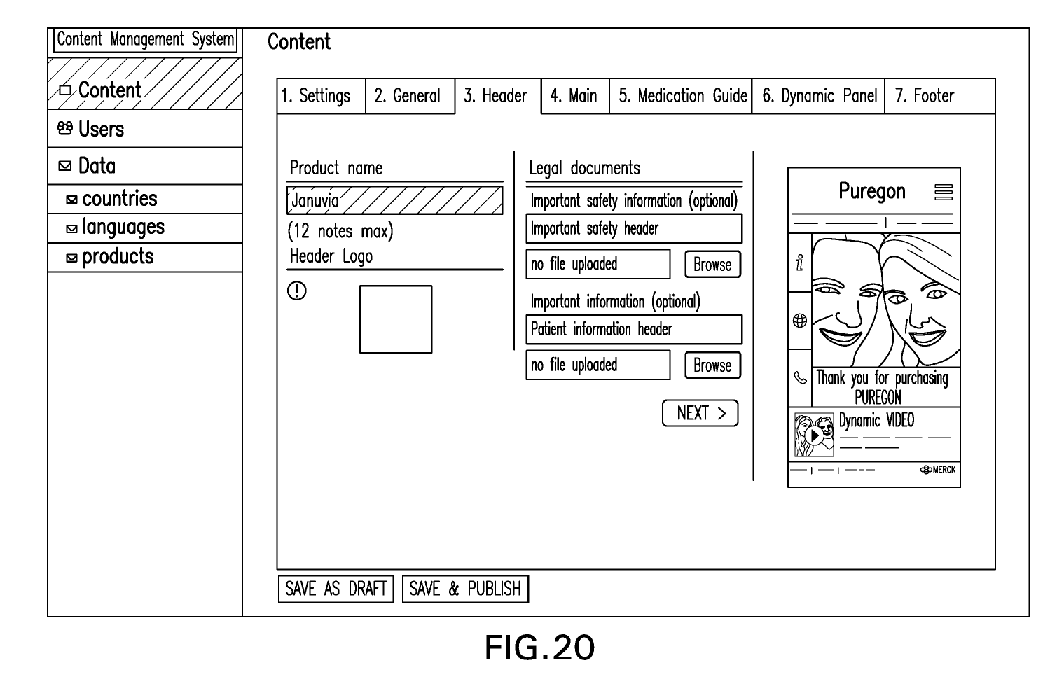

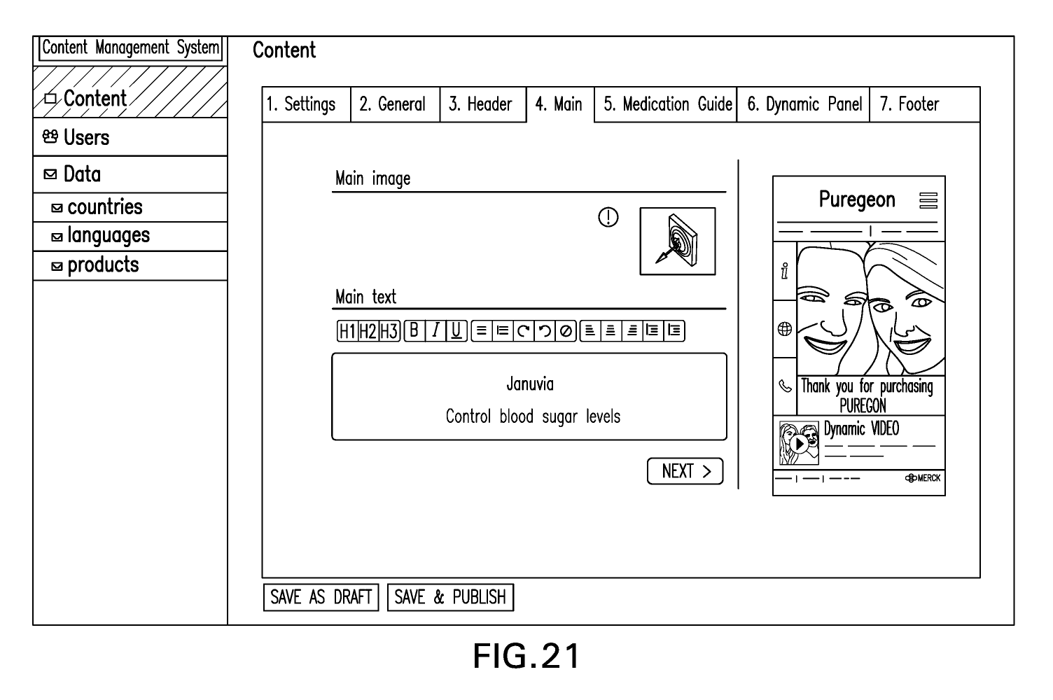

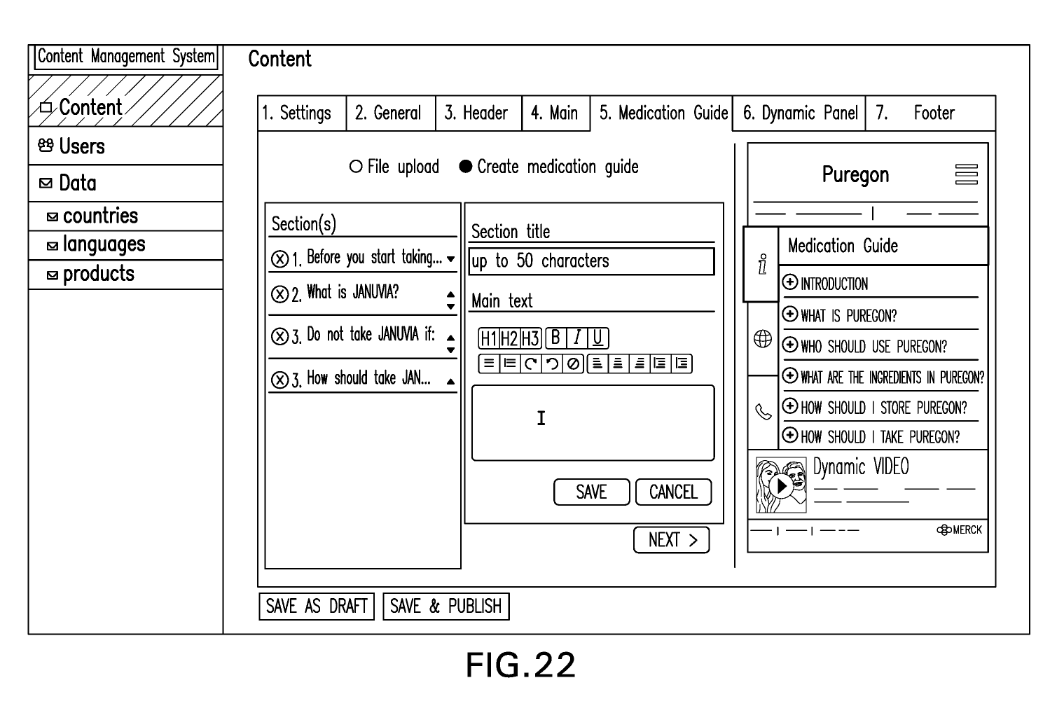

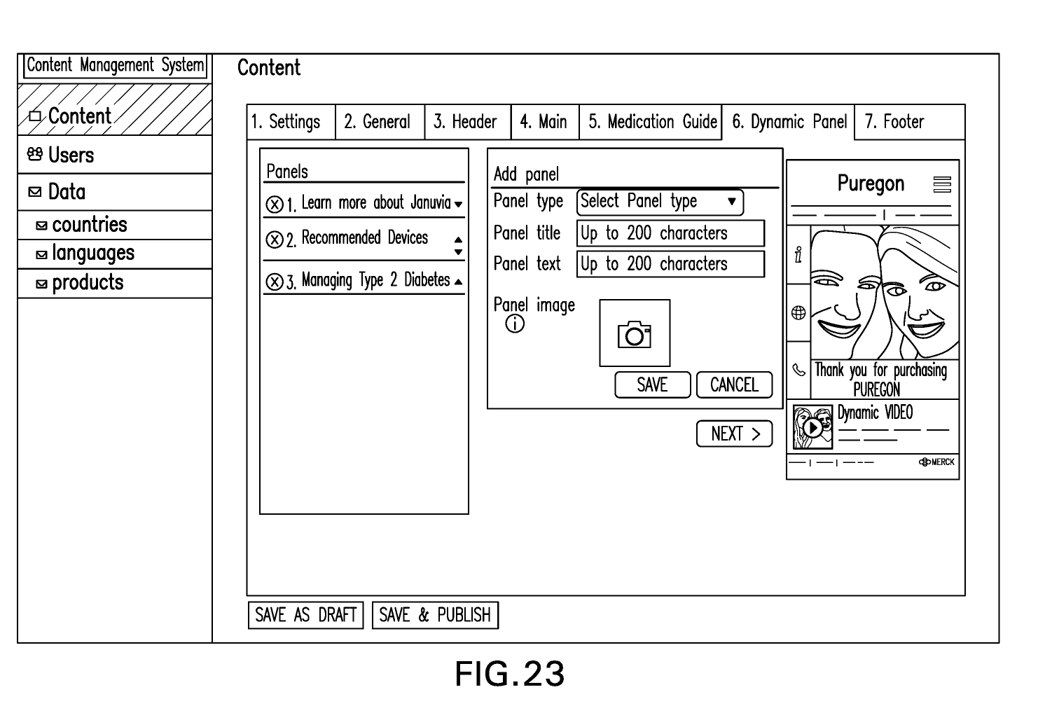

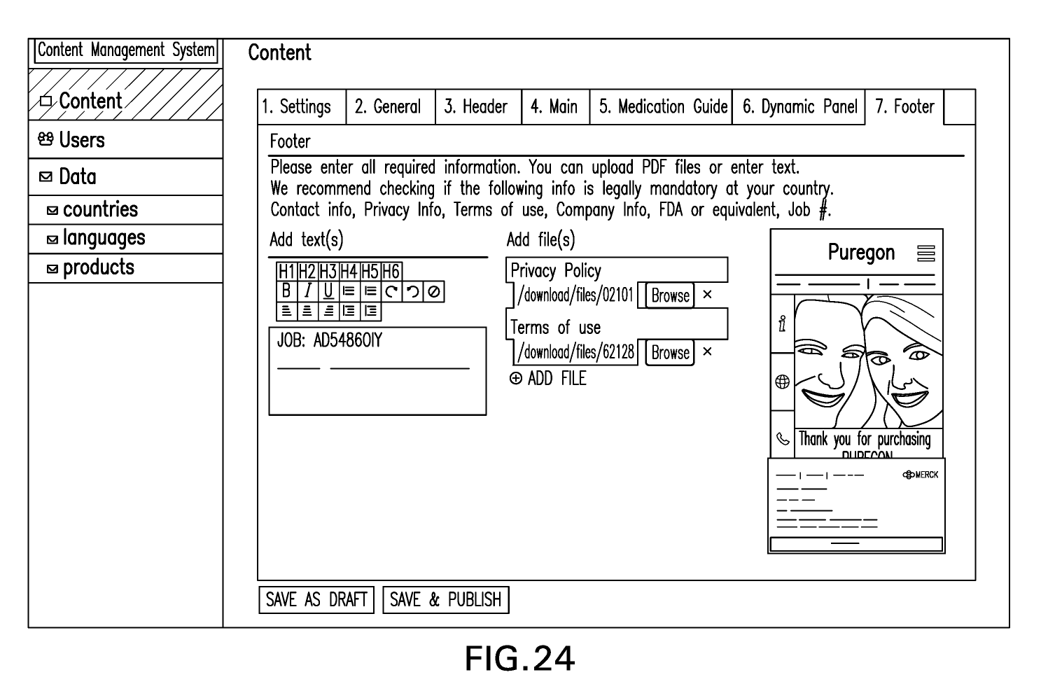

FIGS. 18-24 show examples of data input or editing screens as would be utilized by a back end user in accordance with the procedure described above and shown in FIG. 5. FIG. 18 shows an example of a data input or editing screen in which country, product, and language settings are defined. FIG. 19 shows an example of a data input or editing screen relating to general product information. FIG. 20 shows an example of a data input or editing screen relating to the header content. FIG. 21 shows an example of a data input or editing screen relating to main content for the product information that would be displayed per the presentation template 155. FIG. 22 shows an example of a data input or editing screen relating to the medication guide content for a pharmaceutical product. FIG. 23 shows an example of a data input or editing screen relating to the dynamic panel section of the presentation template 155, in which a variety of information formats, web addresses, documents, and file types can be associated with a specific product record. FIG. 24 shows an example of a data input or editing screen relating to the footer section of the presentation template 155.

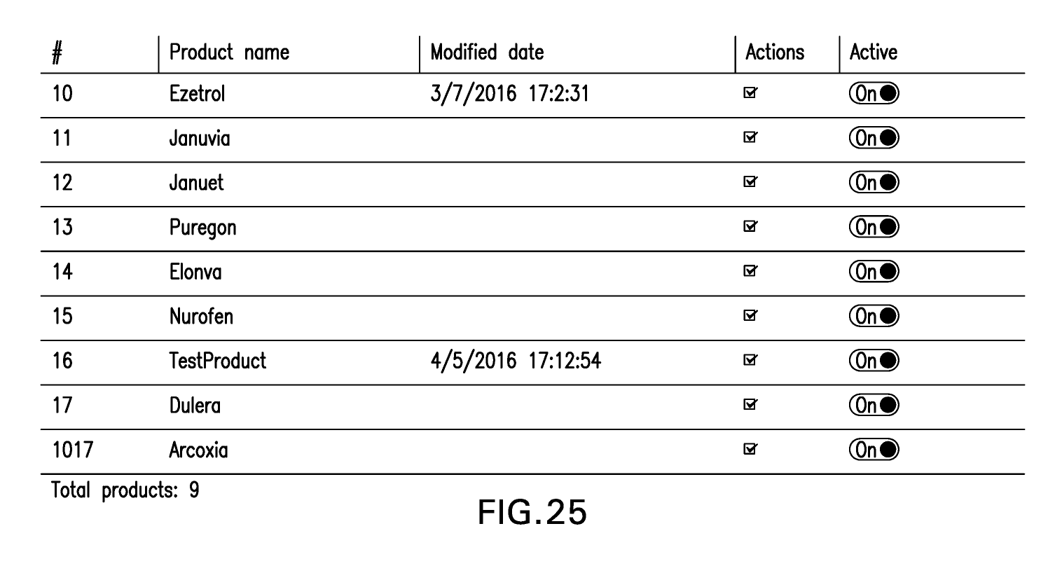

FIG. 25 shows an exemplary schema established for a database for maintaining a set of records in accordance with one exemplary embodiment of the present invention. A unique key is used to identify each particular record that the product or marketing managers will create to organize content for each specific product, which is accessible by any number of end users via the DataMatrix Barcode scanning and identification process discussed above.

The above-described preferred embodiments are intended to illustrate the principles of the invention, but not to limit its scope. Various other embodiments, modifications and equivalents to these preferred embodiments may occur to those skilled in the art upon reading the present disclosure or practicing the claimed invention. Such variations, modifications and equivalents are intended to come within the scope of the invention and the appended claims.

What is claimed is:

1. A system for presenting product-specific content to a user, comprising:
a) a computer network, comprising a client device, a digital content server communicatively coupled to the client device, and an interconnected data communications network;
b) wherein the client device includes
(i) a client microprocessor;
(ii) a client memory;
(iii) an optical scanner configured to capture and decode a dataset embedded within a barcode affixed to a product, the dataset comprising a unique identifier for the product, and store the dataset in the memory,
(iv) a barcode data parsing rule, and
(v) a client application stored in the client memory, the client application having program instructions that, when executed by the client microprocessor, will cause the client microprocessor to parse the dataset in accordance with the barcode data parsing rule to identify the unique identifier for the product, and to transmit the unique identifier to the digital content server via the interconnected data communications network;
c) wherein the digital content server includes
(i) a server microprocessor,
(ii) a server memory,
(iii) a product information database containing a record associating the unique identifier for the product with the product-specific content for the product,
(iv) a content management system for creating the record associating the unique identifier for the product with the product-specific content for the product, and
(v) a server application stored in the server memory, the server application having program instructions that, upon receiving the unique identifier from the client device, causes the server microprocessor to search the product information database for product-specific content based on the unique identifier, and to transmit the product-specific content to the client device via the interconnected data communications network; and
d) wherein the client application on the client device further comprises program instructions that, when executed by the client microprocessor, will cause the client processor to present the product-specific content on an output device associated with the client device.

2. The system of claim 1, wherein:
a) the output device includes a display screen;
b) the client device further comprises a presentation template defining a layout for displaying the product-specific elements on the display screen; and
c) the client application is configured to display the product-specific content on the display screen in accordance with the layout defined by the presentation template.

3. The system of claim 2, wherein:
a) the layout defined by the presentation template for the display screen includes a program control element displayed on the display screen, the program control element configured to initiate playback of the product-specific content on the client device when the program control element is activated by an end user.

4. The system of claim 2, wherein:
a) the layout defined by the presentation template for the display screen includes a input control element displayed on the display screen, the input control element configured to initiate receiving user input from an end user when the input control element is activated by the end user; and
b) the client application is further configured to transmit the user input to the digital content server via the data communications network.

5. The system of claim 4, wherein, responsive to receiving the user input from the client device, the digital content server is further configured to modify a record in the product information database based on the user input.

6. The system of claim 1, wherein the client device further comprises:
c) a local database configured to store an object suited for determining whether the unique identifier is valid; and
d) a barcode input validation configured to compare the unique identifier to the object in the local database prior to the unique identifier being transferred to the digital content server by the network interface.

7. The system of claim 1, wherein the unique identifier comprises a Global Trade Identification Number (GTIN).

8. The system of claim 1, wherein the server application on the digital content server further comprises program instructions that, when executed by the server microprocessor, will cause the server microprocessor to transmit an error message to the client device if the product information database does not contain product-specific content associated with the unique identifier.

9. The system of claim 1, wherein the server application on the digital content server further comprises program instructions that, when executed by the server microprocessor, will cause the server microprocessor to transmit an error message to the client device if the product information database does not contain product-specific content associated with the unique identifier.

10. The system of claim 1, wherein the product-specific content comprises:
a) an alphanumeric string of text; or
b) a digital image file; or
c) a digital text file; or
d) a digital sound file; or
e) a digital music file; or
f) a digital video file; or
g) an executable program file; or
h) a digital data file; or
i) a link to a network resource; or
j) a combination of one or more thereof.

11. In a computer network comprising a client device, a digital content server and a data communications network, a method of presenting product-specific content on the client device, the method comprising the steps of:
a) receiving on the client device an alphanumeric string produced by scanning a visible barcode with a barcode scanner;
b) on the client device, extracting a unique identifier from the alphanumeric string by parsing the alphanumeric string in accordance with a barcode parsing rule stored on the client device;
c) transmitting the unique identifier to the digital content server via the data communications network;
d) on the digital content server, comparing the unique identifier to records stored in a product information database to find a match for the unique identifier;
e) on the digital content server, transmitting and error message to the client device via the data communications network if no match is found in the product information database;
f) on the digital content server, if the match is found, retrieving from the product information database product-specific content associated with the unique identifier and transmitting the product-specific content to the client device via the data communications network; and
g) on the client device, presenting the product-specific content. in accordance with a layout defined by a presentation template;

12. The system of claim 11, further comprising:
a) storing on the client device a presentation template defining a layout for displaying the product-specific elements; and
b) displaying the product-specific content on the display screen in accordance with the layout defined by the presentation template.

13. The system of claim 11, wherein the product-specific content comprises:
c) an alphanumeric string of text; or
d) a digital image file; or
e) a digital text file; or
f) a digital sound file; or
g) a digital music file; or
h) a digital video file; or
i) an executable program file; or
j) a digital data file; or
k) a link to a network resource; or
l) a combination of one or more thereof.

14. The method of claim 11, further comprising the steps of:
a) on the digital content server, using a content management system to store the unique identifier in the product information database; and
b) with the content management system, creating an association in the product information database between the unique identifier and the product-specific content.
